(19) United States
(12) Patent Application Publication
(10) Pub. No.: US 2014/0098676 A1
(43) Pub. Date: Apr. 10, 2014

(54) METHOD FOR MONITORING CONNECTIVITY BY MEANS OF SUBSCRIBER TERMINAL DEVICE, AND CONTROL METHOD THEREFOR

(71) Applicants: Akihiko Tsuchiya, Tokyo (JP); Masao Niibe, Tokyo (JP); Takayuki Kanno, Tokyo (JP); Yoshihiro Ashi, Tokyo (JP)

(72) Inventors: Akihiko Tsuchiya, Tokyo (JP); Masao Niibe, Tokyo (JP); Takayuki Kanno, Tokyo (JP); Yoshihiro Ashi, Tokyo (JP)

(73) Assignee: HITACHI, LTD., Tokyo (JP)

(21) Appl. No.: 14/009,768

(22) PCT Filed: Apr. 2, 2012
(86) PCT No.: PCT/JP2012/058927

§ 371 Date: Nov. 6, 2013

(30) Foreign Application Priority Data
Apr. 5, 2011 (JP) 2011-083246

(51) Int. Cl. H04L 12/26

(52) U.S. Cl. CPC H04L 43/0811
USPC 370/241.1; 370/248

(57) ABSTRACT

When a communications carrier uses another company's network as a relay network, it is necessary to monitor the health of and to perform maintenance for the lines from end to end in the other company's network as well as the network managed by this carrier. Terminal devices capable of terminating a CCM frame or other OAM signal are installed in users bases, and the health is monitored from end to end between the bases. Furthermore, a control device that controls the terminal devices is installed in the VLAN network used by the user, and remote control of the terminal devices is implemented from the controller. Table information held by the controller is managed collectively under the leadership of an operator, and information about the subordinate terminal devices connected to the controller is reported to the operator on the basis of results of the MAC learning by the controller. IDs managed by the carrier are specified in the connectivity monitoring segments by the operator, and connectivity can be monitored segment by segment.

### INCORPORATION BY REFERENCE

The present application claims priority from Japanese application JP 2011-083246 filed on Apr. 5, 2011, the content of which is hereby incorporated by reference into this application.

### TECHNICAL FIELD

The present invention relates to a network configuration for monitoring connectivity of a communication line that strides over a packet communication network in different manager and a method for controlling the network configuration.

### BACKGROUND ART

Recently, Ethernet (trademark) rapidly becomes widespread not only in a LAN (Local Area Network) area but also in a carrier network such as a wide-area Ethernet service. However, as compared to other protocols used in conventional transmission networks such as an ATM (Asynchronous Transfer Mode), an OAM (Operation Administration and Maintenance) function is not defined with respect to a packet communication protocol starting with Ethernet. Therefore, maintenance and management functions thereof have been addressed.

Recently, in ITU-T (International Telecommunication Union Telecommunication Standardization) and IEEE (Institute of Electrical and Electronics Engineers, Inc.) as a standard-setting organization, discussions about the maintenance and management functions are performed. At this time, ITU-T recommendation Y.1731 (Non Patent Literature 1) and IEEE 802. lag (Non Patent Literature 2) are specified and an OAM function for Ethernet is introduced. In addition, specifications of a path switching (protection) system G 8031 (Non Patent Literature 3) using an OAM function are also completed.

Through the process, since maintenance and management are enabled with regard to communication service in an Ethernet network, practical application of the OAM function starts in a packet communication network including Ethernet. Ethernet is usually applied to a LAN owned by an individual user or a corporate user in many cases. Since Ethernet has the maintenance and management functions, an operation thereof is taken notice of also in infrastructure services presented by a carrier. Also about a customer station equipment installed in a user's home, introduction of Ethernet OAM (hereinafter, referred to as Ethernet OAM) is studied.

Conventionally, a carrier has presented services for establishing a relay network between user's sites through a common carrier leased line or L2-VPN (Layer 2 Virtual Private Network) service. The user of this case may be mainly a corporate user such as a corporate, in many cases. A corporate user has a plurality of sites according to a size of a business such as a headquarters office and a branch office in many cases and mutually performs communication between sites by using a common carrier leased line or L2-VPN service presented by a carrier. When using the services, a corporate user easily shares servers and files as a merit between a plurality of sites. In addition, a network can be established dispersedly into a headquarters office and a data center in consideration of diversification of risk at the time of disaster.

In services for establishing a relay network for connecting both sites of users at these places separated geographically, a band guarantee is performed in accordance with a contract with a user in the relay network presented by a carrier. An access network provider that presents an infrastructure near a user for communication between sites mutually separated, or a carrier that presents a core network for connecting both of access networks strides over a plurality of networks in different managers. Therefore, it is difficult to perform monitoring from end to end between devices used by users.

Along with standardization of the above-described Ethernet OAM, maintenance and management can be performed in a protocol of a Layer 2 (hereinafter, referred to as an L2). Further, an access network provider moves from a common carrier leased line device with high cost to a packet communication device. As described above, when both of an access network and a core network are connected through a packet communication device, connection for consistently managing them is conventionally difficult; however, can be easily established. Concretely, a carrier that presents a core network installs a remote device in a user site. Further, a method for managing the entire communication between user sites over an access network provider is being introduced.

### CITATION LIST

### Non Patent Literature

Non Patent Literature 1: ITU-T Recommendation Y. 1731
Non Patent Literature 2: IEEE 802. lag
Non Patent Literature 3: ITU-T Recommendation G 8031/Y. 1342

### SUMMARY OF INVENTION

### Technical Problem

When a large-scale network between users is presented up to now, a communications carrier such as a carrier pays reasonable cost according to a scale of the network to establish it. Recently, a case of using an access network presented by other companies increases to enlarge an area of the L2-VPN service. The above-described cost reduction is achieved by using an area network established by a regional agent being an access network provider. When a communications carrier uses another company's network as a relay network, it is necessary to monitor the normality of and to perform maintenance for the lines from end to end in the other company's network as well as the network managed by this carrier. To monitor the lines from end to end, it is necessary to install a terminal device that has been prepared by the communications carrier in a user's home that uses an L2-VPN service. The terminal device is installed in a user's home, so it must perform remote control via the other company's network, and the method of that remote control must be addressed. Further, in case of trouble due to a terminal failure or a communication path error, there is the possibility that a trouble is detected not only from a device of a communications carrier such as a carrier but also from devices of other companies and unnecessary malfunction reports are congested. To solve the problems, a burden onto user traffic is relieved by identifying a failure segment effectively and reducing unnecessary malfunction reports.

### Solution to Problem

Terminal devices capable of terminating a CCM frame or other OAM signal are installed in user's bases, and the normality is monitored from end to end between bases. Further, a control device that controls the terminal devices is installed in the VLAN network used by the user, and remote control of the terminal devices is achieved by the controller. Table information held by the controller is managed collectively under the leadership of an operator, and information on the subordinate terminal devices connected to the controller is reported to the operator based on results of MAC learning by the controller. IDs managed by the carrier are specified in connectivity monitoring segments by the operator, and connectivity can be monitored in units of segments.

### Advantageous Effects of Invention

According to the present invention, remote control of each terminal device can be achieved via the controller from a MAC address learnt by the controller under the leadership of the operator. The operator can set a subordinate relationship of the terminal device via the controller. Further, the operator can set IDs of the connectivity monitoring segments of connecting a master terminal device and a slave terminal device, and those of connecting the controller and each terminal device. The operator can manage and prepare collectively a table indicating connection information between respective terminal devices that make a connection between bases in the L2-VPN service area and that indicating connection information between the controller and respective terminal devices. Based on the above, the operator can confirm the normality of not only a main signal route through which a user frame flows, but also a control route. Through the apparent connectivity monitoring segments, when a terminal failure in case of trouble or a failure portion at the time of a communication path error is easily identified and unnecessary malfunction reports are reduced, the operator can relieve a burden onto user traffic.

### BRIEF DESCRIPTION OF DRAWINGS

FIG. 1 illustrates one example of a network construction of an L2-VPN network according to an embodiment of the present invention;

FIG. 2 illustrates one example of a network construction example according to the embodiment of the present invention;

FIG. 3 illustrates one example of a process flow of a control method performed by an operator at the time of constructing a network according to the embodiment;

FIG. 4A illustrates one example of a table into which an operator needs to input at the time of constructing the embodiment of the present invention;

FIG. 4B illustrates one example of a table into which the operator needs to input at the time of constructing the embodiment of the present invention;

FIG. 4C illustrates one example of a table into which the operator needs to input at the time of constructing the embodiment of the present invention;

FIG. 4D illustrates one example of a table into which the operator needs to input at the time of constructing the embodiment of the present invention;

FIG. 4E illustrates one example of a table into which the operator needs to input at the time of constructing the embodiment of the present invention;

FIG. 4F illustrates one example of a table into which the operator needs to input at the time of constructing the embodiment of the present invention;

FIG. 5 illustrates one example of a connectivity monitoring range capable of being monitored by an operator according to the embodiment of the present invention;

FIG. 6 is the entire operation sequence diagram in which a control device (controller) is registered by an operator;

FIG. 7 is the entire operation sequence diagram in which a terminal device (Box-M/S) is registered by the operator;

FIG. 8 illustrates one example of a process flow of the control device (controller);

FIG. 9A illustrates one example of an internal table about connection information to be managed by the control device (controller);

FIG. 9B illustrates one example of an internal table about connection information to be managed by the control device (controller);

FIG. 9C illustrates one example of an internal table about connection information to be managed by the control device (controller);

FIG. 9D illustrates one example of an internal table about connection information to be managed by the control device (controller);

FIG. 9E illustrates one example of an internal table about connection information to be managed by the control device (controller);

FIG. 9F illustrates one example of an internal table about connection information to be managed by the control device (controller);

FIG. 9G illustrates one example of a configuration of the control device (controller);

FIG. 10 illustrates one example of a process flow of a center side terminal device (Box-M);

FIG. 11A illustrates one example of a table about connection information to be managed by the center side terminal device (Box-M);

FIG. 11B illustrates one example of a table about connection information to be managed by the center side terminal device (Box-M);

FIG. 11C illustrates one example of a table about connection information to be managed by the center side terminal device (Box-M);

FIG. 11D illustrates one example of a table about connection information to be managed by the center side terminal device (Box-M);

FIG. 11E illustrates one example of a configuration of the center side terminal device (Box-M);

FIG. 12 illustrates one example of a process flow of a base side terminal device (Box-S);

FIG. 13A illustrates one example of a table about connection information to be managed by the base side terminal device (Box-S);

FIG. 13B illustrates one example of a table about connection information to be managed by the base side terminal device (Box-S);

FIG. 13C illustrates one example of a table about connection information to be managed by the base side terminal device (Box-S);

FIG. 13D illustrates one example of a table about connection information to be managed by the base side terminal device (Box-S); and

FIG. 13E illustrates one example of a configuration of the base side terminal device (Box-S).

### DESCRIPTION OF EMBODIMENTS

Hereinafter, with reference to drawings, configurations and operations of a network according to the present invention will be described by using as an example an Ethernet OAM configuration specified by ITU recommendation Y. 1731 (Non Patent Literature 1) and operations thereof.

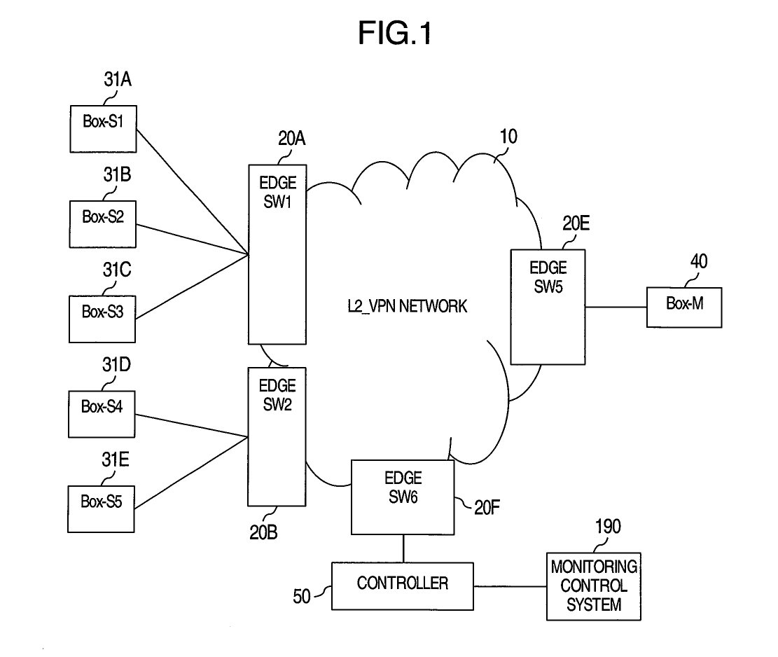

FIG. 1 illustrates one example of a network configuration of an L2-VPN network 10 according to an embodiment of the present invention. In a network 1, a terminal (hereinafter, referred to as a user device) of a user (subscriber) subscribing to a service for making a connection between bases is arranged at each site, and conditions that a Box-S31 and a Box-M40 being a terminal device similarly arranged at each site connect the user devices to the L2-VPN network 10 are illustrated. Here, the Box-M40 is a terminal device that is, for example, arranged at a center side of a large city in which a user summarizes each base. Further, the Box-S31 is a terminal device that is, for example, arranged by a user at a base side of a local region. This terminal device may be a single device, or incorporated into a device of a home gateway for Edge installed at a user's home and a station of a subscriber, or incorporated into a relay device such as a router or a switch.

The terminal device is, for example, a device that terminates an OAM signal of a CCM (Continuity Check Message) frame to be used inside a base of the user or outside a base of the user. In the present embodiment, the terminal device is arranged inside the base of the user and further may be arranged outside a base near to the base of the user.

A terminal device installed at each site is connected to an edge device 20 such as an L2 switch arranged at an edge of the relaying L2-VPN network 10, and performs communication in a network under setting of ULAN, if needed.

Here, the edge device 20, the Box-M40, and the Box-S31 are, for example, devices owned by a carrier being a communications carrier. A usage pattern that the Box-M40 and the Box-S31 are lent to the user by the carrier and installed in a user's home or station is supposed. Further, a network between the edge device 20 and a terminal device such as the Box-M40 or the Box-S31 may be configured by a network managed by a regional agent other than a carrier such as an access network provider. Further, a network interposed by the edge device may be considered as a network managed by a carrier. About the fact that who manages which part of the network of FIG. 1, various variations are considered also in other than the above-described examples. The present embodiment can be performed even if how the network 1 is partitioned and managed.

In FIG. 1, five Boxes-S31 of a Box-S1 (31A), a Box-S2 (31B), a Box-S3 (31C), a Box-S4 (31D), and a Box-S5 (31E) are arranged as terminal devices at the base side of the user in a local region. Further, one Box-M40 is arranged as a terminal device at the center side. In addition, a controller 50 that remotely controls each terminal device is also connected via the edge device 20F such as the L2-VPN network 10 and the L2 switch. The controller 50 is connected to a monitoring control system 190 and a communication path (control plane) constructed for transmitting and receiving Ethernet OAM signals apart from a communication path (data plane) through which a user frame flows. The monitoring control system 190 is composed of a server group as hardware and an application software group. A device management of the controller 50, the Box-M40, and the Box-S31 is performed via the control plane and further constructions and monitoring of the network are also performed at the same time.

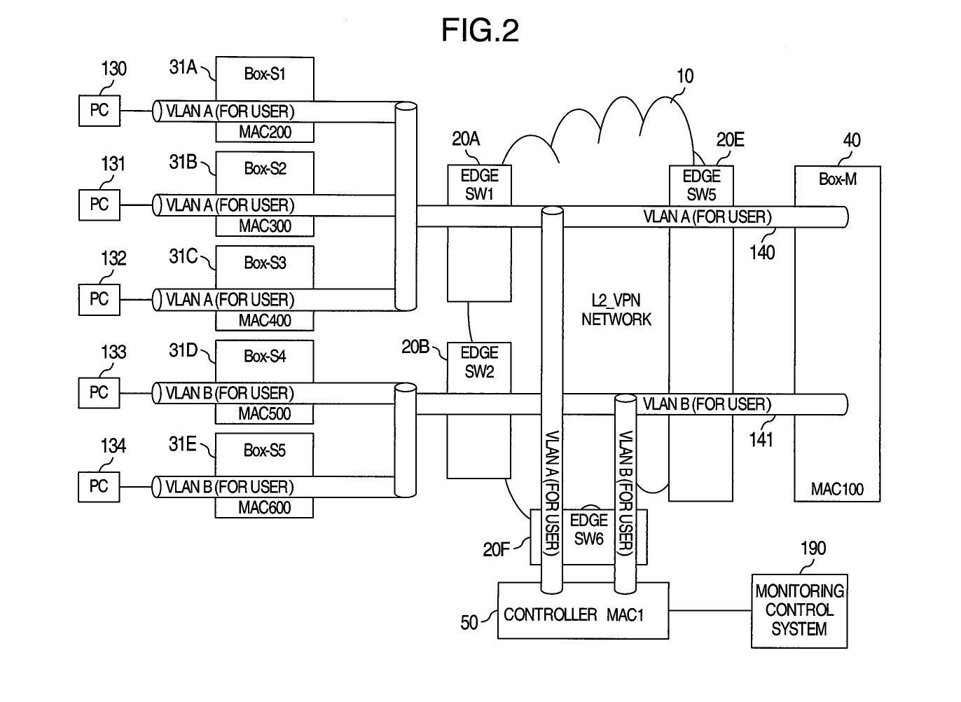

FIG. 2 illustrates one example of a network construction example according to the embodiment of the present invention. The controller 50, the Box-M40, the Box-S1 (31A), the Box-S2 (31B), and the Box-S3 (31C) construct via the L2-VPN network 10 a network set in a VLAN A (for users) 140. Similarly, the controller 50, the Box-M40, the Box-S4 (31D), and the Box-S5 (31E) construct via the L2-VPN network 10 a network set in a VLAN B (for users) 141. Between respective terminal devices, the VLAN A (for users) 140 and the VLAN B (for users) 141 are communication paths (data plane) through which a user frame used in communication between the base and the center by the user flows, and also a communication path (control plane) for transferring Ethernet OAM signals that perform connectivity monitoring between terminal devices. Further, a pattern that a plurality of base side Boxes-S31 are subject under one center side Box-M40 is taken between respective terminal devices. With reference to one example, in some corporate network, a terminal device installed in a branch office is arranged in a user device connected ahead of the base side Box-S31. Further, a data center that controls each branch office is installed in a user device connected ahead of the center side Box-M40. They construct networks that mutually transmit and receive signals. The above-described example is adamantly one example, and the present embodiment is not necessarily limited to the above-described example.

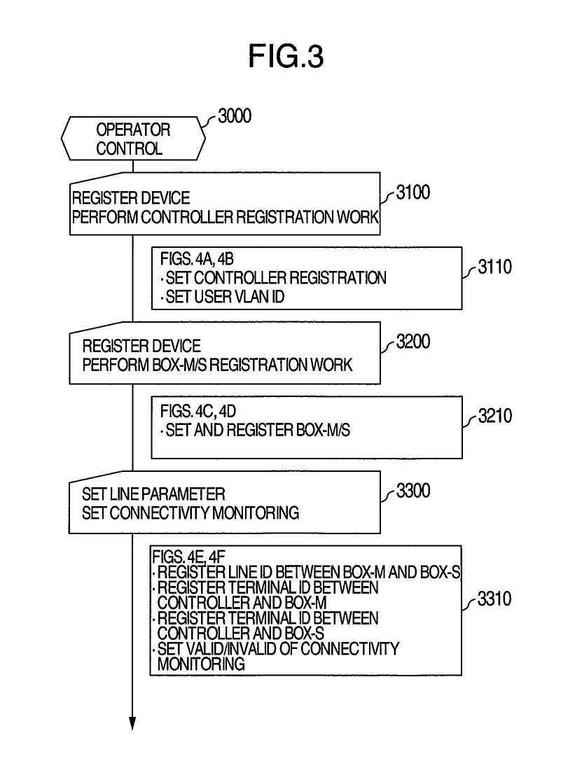

FIG. 3 illustrates one example of a process flow about a control method performed by the operator at the time of constructing the network according to the embodiment. The controller 50 and a Box 30 are supposed to be preliminarily installed and connected to the edge SW 20 in an initial state. A user terminal connected to the controller 50 is referred to as a Box.

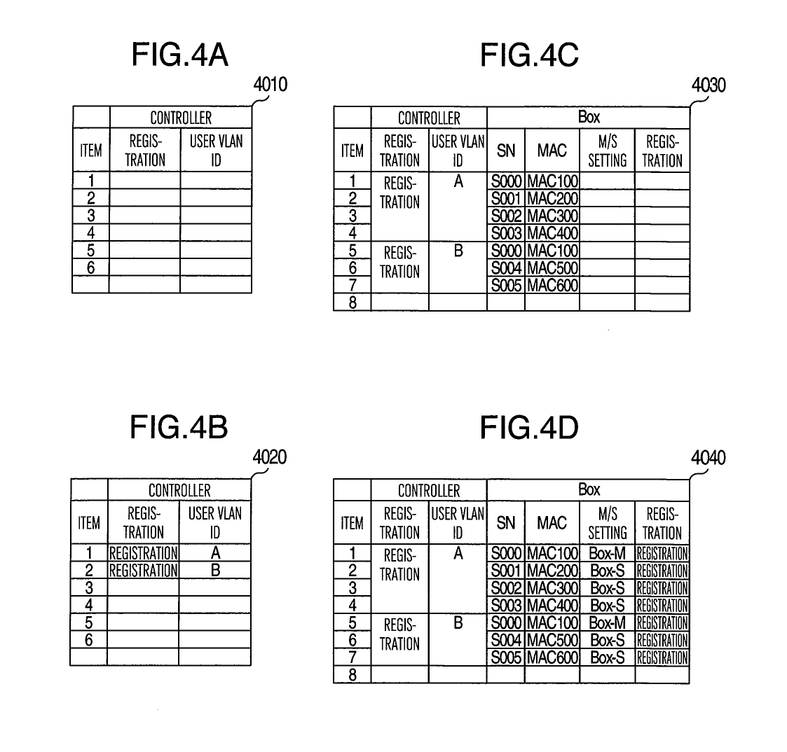

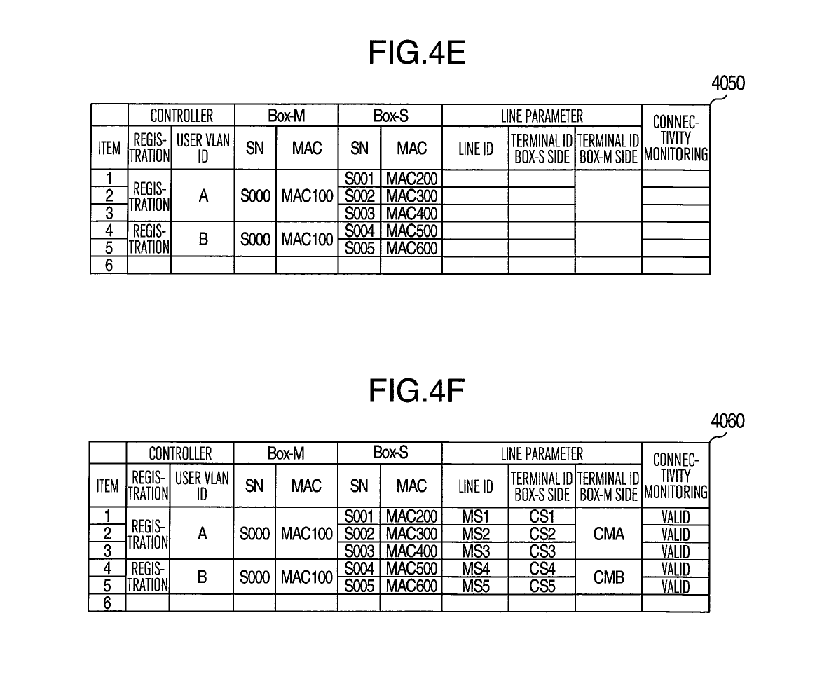

At the beginning, the operator registers devices and performs a controller registration work 3100. The operator registers the controller and a user VLAN ID in a table 4010 illustrated in FIG. 4A. The user VLAN ID is a VLAN ID for a communication path through which a user frame used in communication between the base and the center by the user flows. The operator preliminarily constructs a network through which a user frame flows, and therefore previously grasps the user VLAN ID. Here, since the above-described network 1 of FIG. 2 is taken as an example, a VLAN ID A and a VLAN ID B are registered in the user VLAN ID in a table 4020 of FIG. 4B.

Next, a device registration and a Box-M/S registration work 3200 are performed. An M/S (Master/Slave) setting and registration of Box-M/Box-S devices illustrated in a table 4030 of FIG. 4C are input. In FIG. 4C, the registration and the user VLAN ID of the controller registered in FIG. 4B are reflected, and SNs (Serial Number) and MAC addresses of the user terminal connected to the controller 50 corresponding to this VLAN ID are registered. The SN is information for uniquely discriminating user terminals and, for example, a serial number given by a manufacturer at the time of manufacturing a device and identification information newly given by a manager that manages a network of a communication carrier may be used. A method for obtaining an SN and a MAC address of each connected Box by inputting the user VLAN ID A will be described later.

In a table 4040 of FIG. 4D, a state where the setting is reflected is illustrated. Four Boxes belong to the user VLAN ID A, and the SNs are S000, S001, S002, and S003. Further, a Box with the SN of S000 and the MAC address of MAC 100 is registered as the Box-M40, and a Box with the SN of S001 and the MAC address of MAC 200 is registered as the Box-S1 (31A). Similarly, a Box with the SN of S002 and the MAC address of MAC 300 is registered as the Box-S2 (31B), and a Box with the SN of S003 and the MAC address of MAC 400 is registered as the Box-S3 (31C).

Three Boxes belong to the user VLAN ID B, and the SNs are S000, 5004, and S005. Further, a Box with the SN of S000 and the MAC address of MAC 100 is registered as the Box-M(40), and a Box with the SN of S004 and the MAC address of MAC 500 is registered as the Box-S4 (31D). Similarly, a Box with the SN of S005 and the MAC address of MAC 600 is registered as the Box-S5 (31E)

Next, setting of line parameters and setting of the connectivity monitoring 3300 are performed. A table 4050 of FIG. 4E differs from the table 4040 of FIG. 4D in an arrangement, and a table is rearranged and reflected by performing the device registration and the Box-M/S registration work 3200. As a way to see a table, the Box-S1 (31A) (the SN is S001 and the MAC address is MAC200), the Box-S2 (31B) (the SN is S002 and the MAC address is MAC300), and the Box-S3 (31C) (the SN is S003 and the MAC address is MAC400) are connected under the Box-M40 (the SN is S000 and the MAC address is MAC100) belonging to the user VLAN ID A.

Similarly, the Box-S4 (31D) (the SN is S004 and the MAC address is MAC500) and the Box-S5 (31E) (the SN is S005 and the MAC address is MAC600) are connected under the Box-M40 (the SN is S000 and the MAC address is MAC100) belonging to the user VLAN IDB.

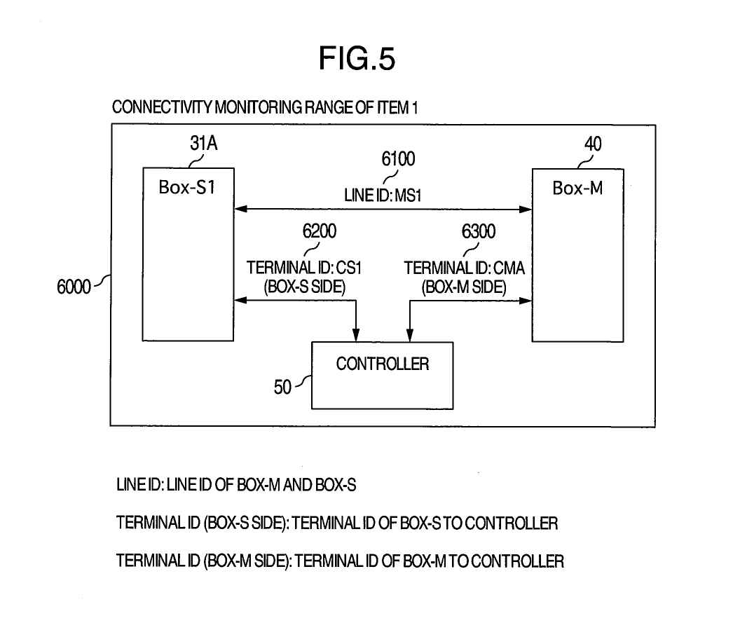

In setting of the line parameters and setting of the connectivity monitoring 3300, a line ID, a terminal ID (Box-S side), a terminal ID (Box-M side), and valid/invalid setting of the connectivity monitoring are performed in a column of an ID in a table 4050 of FIG. 4E. One example of setting of each line parameter is illustrated in FIG. 5. The line ID is an ID indicating a connectivity monitoring segment between the Box-M40 and the Box-S1 (31A). In this example, an MS 1 (6100) is set as the line ID. The terminal ID (Box-S side) is an ID indicating the connectivity monitoring segment between the controller 50 and the Box-S1 (31A). In this example, a CS1 (6200) is set as the terminal ID (Box-S side). Similarly, the terminal ID (Box-M side) is an ID indicating the connectivity monitoring segment between the controller 50 and the Box-M40. In this example, a CMA (6300) is set as the terminal ID (Box-M side). Subsequently, setting of the line parameter is similarly performed and a table 4060 of FIG. 4F is completed.

About connectivity monitoring results in the case where FIG. 5 is taken as an example, the controller 50 confirms the connectivity monitoring results of the terminal ID (Box-M side) between the controller 50 and the Box-M40 as well as those of the terminal ID (Box-S side) between the controller 50 and the Box-S1 (31A). About the connectivity monitoring results of a line ID between the Box-M50 and the Box-S1 (31A), two ways are used; that is, one is to report the results from the Box-M40 and the other is to report the results from the Box-S1. Here, since the Box-M40 acts as a master, the connectivity monitoring results of the line ID are supposed to be reported from the Box-M40. Note, however, that this is adamantly one example, and the present invention is not necessarily limited to the above-described example.

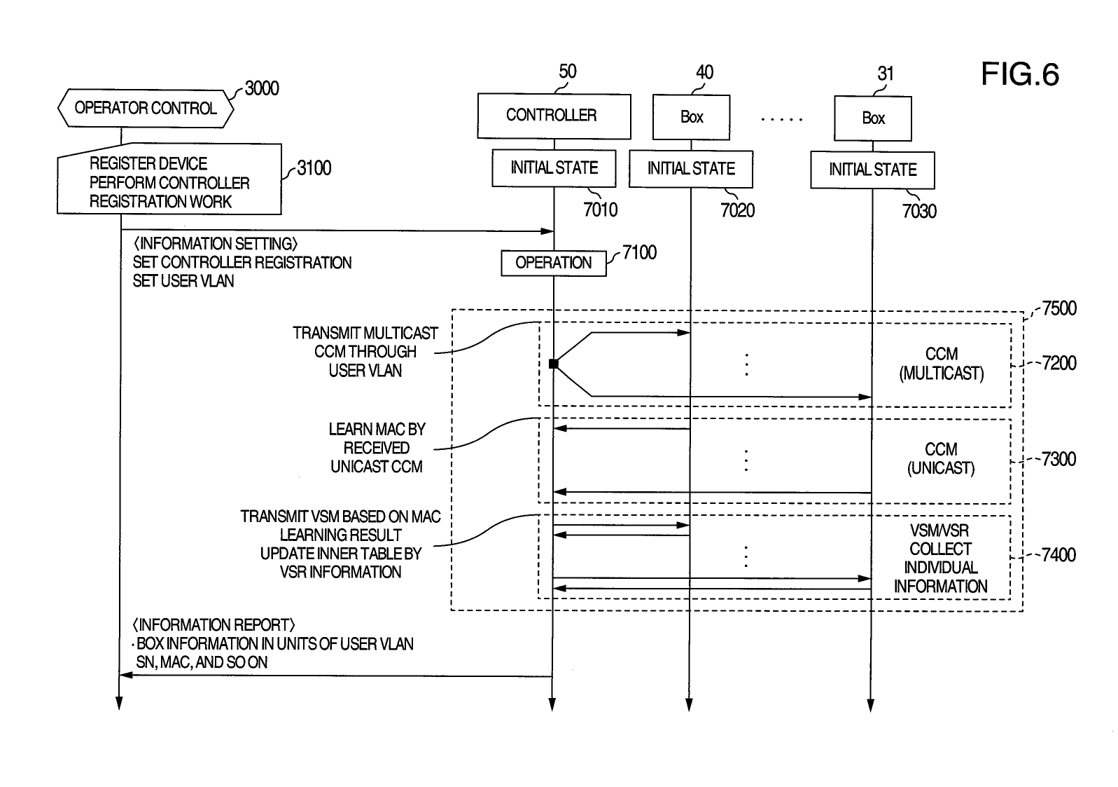

FIG. 6 is the entire operation sequence diagram for registering the control device (controller 50) by the operator. When the device registration and the controller registration work 3100 of FIG. 3 are performed, registration of the controller 50 and setting of the user VLAN ID are performed. The controller 50 is started from an initial state 7010 and operated 7100 through the controller registration and the setting of the VLAN ID by the operator. The controller 50 uses the user VLAN ID set by the operator and transmits a multicast CCM frame to the Box 30 (7200). The Box 30 connected by using the same user VLAN ID continuously receives the multicast CCM frame transmitted from the controller 50. At this time, the Box 30 transmits to the controller 50 a unicast CCM frame signal to which the VLAN ID used by the received multicast CCM frame is attached (7300). When the unicast CCM frame is transmitted, a MAC address of the controller 50 is set to a destination address (Destination MAC Address) (hereinafter, referred to as a DA) to transmit the destination MAC address.

In this case, the CCM (Continuity Check Message) frame used for connectivity monitoring in an Ethernet OAM may be applied.

In the case where a multicast CCM frame is transmitted, for example, a multicast MAC address for the OAM frame specified by non patent literature 1 is used. When this multicast MAC address is used, the terminal device receiving an Eth-CC signal confirms that the multicast MAC address specified by standards is stored in the destination MAC address, for processing.

The controller 50 learns a MAC address of the Box 30 from a source address (Source MAC Address) (hereinafter, referred to as an SA) being the MAC address of the unicast CCM frame transmitted by the Box 30. Next, the controller 50 transmits a VSM frame to which the user VLAN ID is attached by using the learnt MAC address of the Box 30. The VSM frame differs from the CCM frame in that an Opcode is equal to 0x33. The VSM frame is a frame independently settable by a vender, and here is a control frame for asking the Box 30 for information on the SN and the MAC address. A frame format has a static part of a vender itself and ways of various configurations, and therefore is omitted.

The Box 30 that receives the VSM frame to itself transmits information on the SN and the MAC address of itself to the controller 50 through a VSR frame. The VSR frame differs from the CCM frame in that an Opcode is equal to 0x32. The VSR frame is a frame independently settable by the vender, and here is a control frame for reporting information on the SN and the MAC address of the Box 30 itself to the controller 50. A frame format has a static part of the vender itself and therefore is omitted. The MAC address is previously learnt by the controller 50 by using a CCM. Here, the Box 30 transmits the MAC address of itself through the VSR frame again to confirm accord between the SN and the MAC.

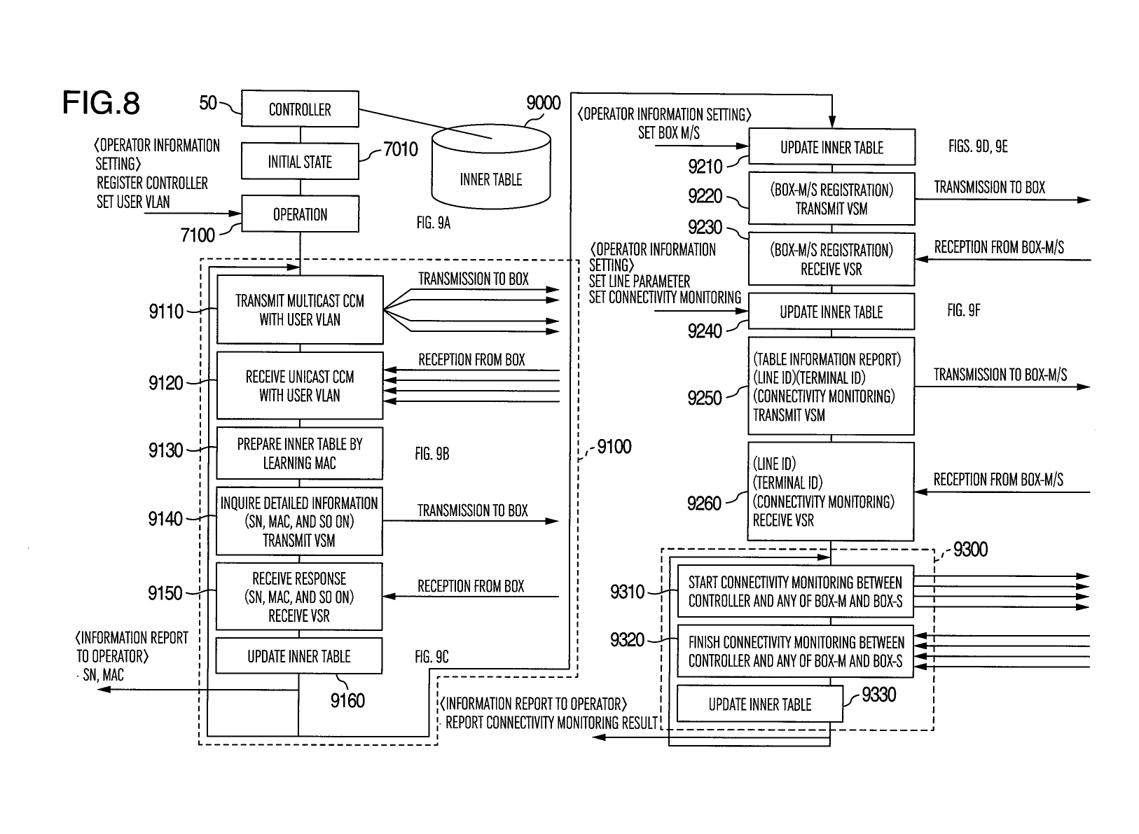

A reference numeral 7400 of FIG. 6 denotes transmission of the VSM frame from the controller 50 to the Box 30 and reception of the VSR frame from the Box 30 to the controller 50. The controller 50 updates an inner table of itself based on the information received from the Box 30 through the VSR frame, and reports the information to the operator side. The report information of this time includes information on the Box 30 connected in units of the user VLAN ID and information on the SN and the MAC address of the Box 30 itself. In the multicast CCM frame 7200, the unicast CCM frame 7300, and the collection of the VSM/VSR individual information 7400 of FIG. 6, the above-described operations may be always continued in a predetermined time interval at the time of the operation 7100 of the controller 50 or later. A reason of the continuation is a newly added information collection purpose of the Box 30. A sequence of only the controller 50 will be described later with reference to FIG. 8. Further, the above-described flow is adamantly one example, and the present embodiment is not necessarily limited to the above-described example.

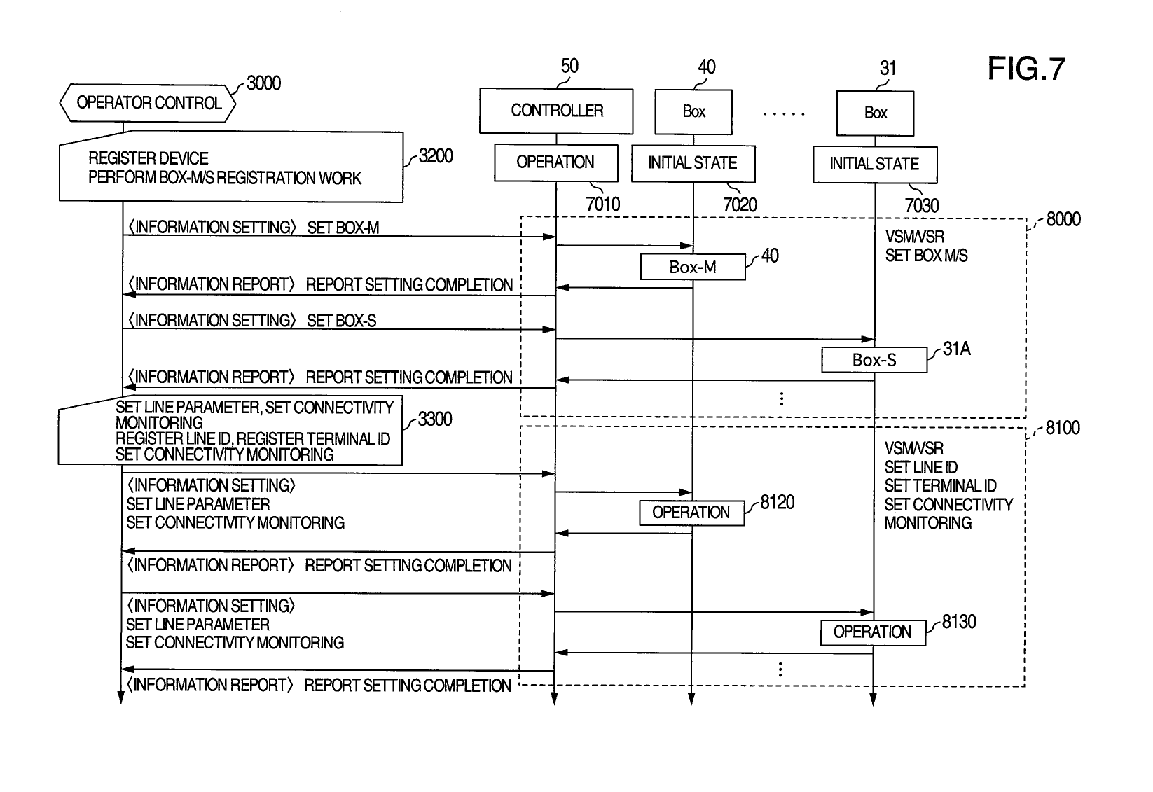

FIG. 7 is the entire operation sequence diagram for registering the terminal device (Box-M/S) by the operator. When the device registration and the Box-M/S registration work 3200 of FIG. 3 are performed, contents input by the operator are reflected on the inner table of the controller 50 for updating. Based on the updated contents of the inner table, the controller 50 transmits registration setting as a master (Box-M40) to the Box 40 through a VSM frame. When the VSM frame is received, the Box 40 starts operations as the Box-M40 based on the setting contents and, through the VSR frame, reports to the controller 50 that it operates as the Box-M40. The controller 50 reports to the operator that setting of the Box-M40 is completed.

Based on the updated contents of the inner table, the controller 50 similarly transmits the registration setting as a slave (Box-S31) to the Box 31 through the VSM frame. When the VSM frame is received, the Box 31 starts operations as a Box-S31A based on the setting contents and, through the VSR frame, reports to the controller 50 that it operates as the Box-S31A. The controller 50 reports to the operator that setting of the Box-S31A is completed. The operations are denoted by a reference numeral 8000.

When the setting of the line parameter and the setting of the connectivity monitoring 3300 of FIG. 3 are performed, contents input by the operator are reflected on the inner table of the controller 50 for updating. Based on the updated contents of the inner table, the controller 50 transmits information on the setting of the line parameter and the valid setting of the connectivity monitoring to the Box-M40 through the VSM frame. When the VSM frame is received, the Box-M40 reflects the setting contents on the table of itself and is in an operating state. Through the VSR frame, the Box-M40 reports to the controller 50 that it is in an operating state. The controller 50 reports to the operator that the setting of the Box-M40 is completed.

Based on the updated contents of the inner table, the controller 50 similarly transmits to the Box-S31 the information on the setting of the line parameter and the valid setting of the connectivity monitoring through the VSM frame. When the VSM frame is received, the Box-S31 reflects the setting contents on the table of itself and is in an operating state. The Box-S31 reports to the controller 50 that it is in an operating state. The controller 50 reports to the operator that the setting of the Box-S31 is completed. The operations are denoted by a reference numeral 8100.

Here, descriptions are made with a focus on the Box-M40 and the Box-S31, and practically, a plurality of Boxes 31 can be registered as the Box-M40 or the Box-S31. The above-described flow is adamantly one example, and the present embodiment is not necessarily limited to the above-described example.

Separately, sequences of only the controller 50, only the Box-M40, and only the Box-S30 will be described later with reference to FIGS. 8, 10, and 12, respectively.

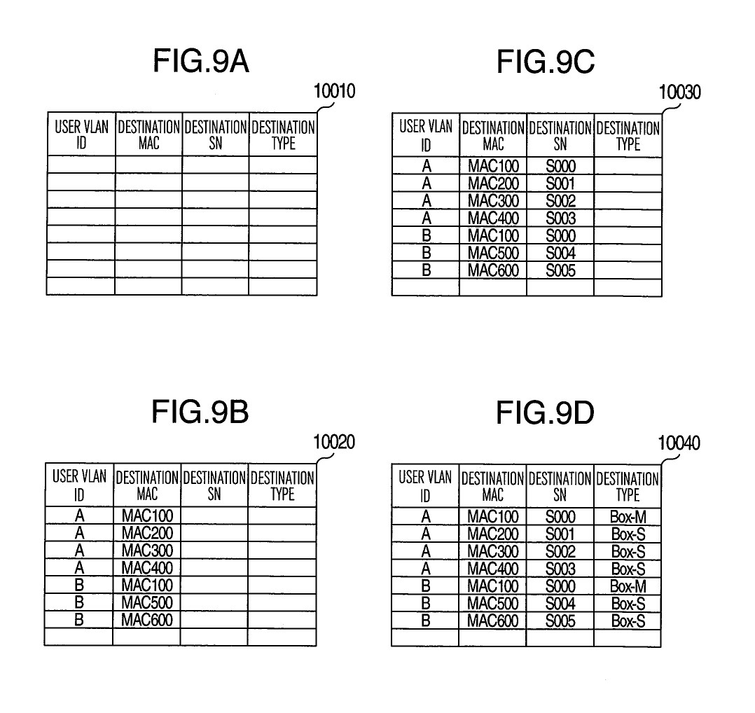

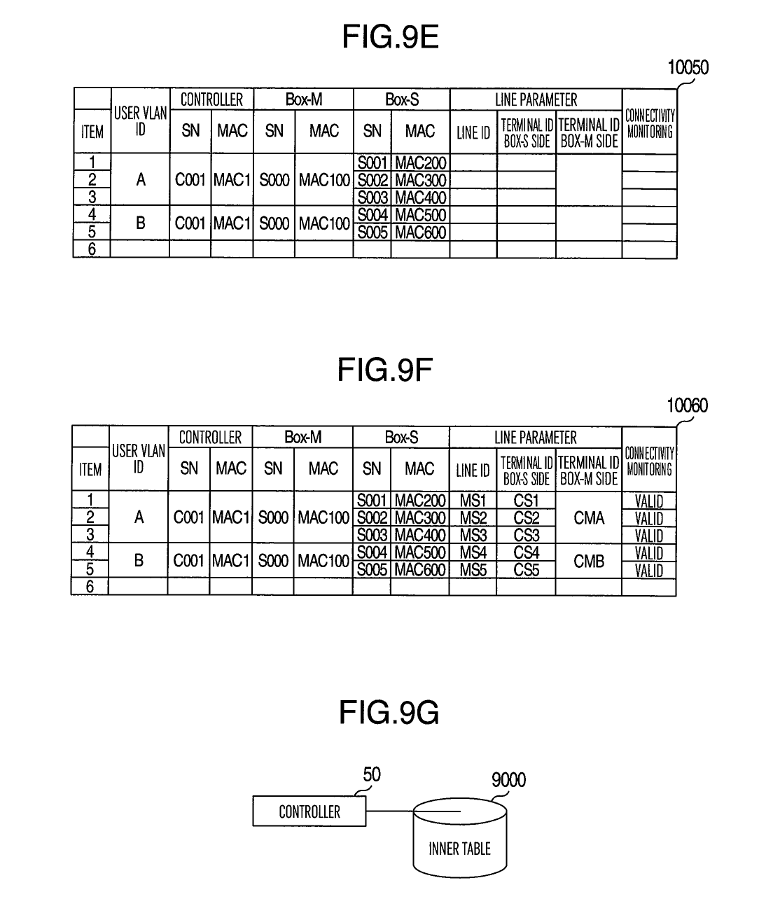

FIG. 8 illustrates one example of a process flow of the control device (controller 50). The controller 50 has an inner table 9000 (FIG. 9G). In an initial state 7010, an inner table 10010 of FIG. 9A is blank. When the registration setting of the controller 50 and the user VLAN ID setting 3100 are performed by the operator, the controller 50 is in an operating state (7100).

When being in an operating state, the controller 50 transmits a multicast CCM with the user VLAN to the Box 31 and the Box 40 by using the user VLAN ID set by the operator (9110). The controller 50 receives a unicast CCM with the user VLAN from the Box 31 and the Box 40 (9120). Further, when the unicast CCM with the user VLAN is received, the controller 50 learns the MAC addresses of the Box 31 and the Box 40, and prepares an inner table (9130).

An inner table 10020 of FIG. 9B results from reflecting the MAC learning result of the Box 31 and the Box 40 on the inner table 10010 of FIG. 9A. Here, since the above-described network 1 of FIG. 2 is taken as an example, a destination MAC corresponds to MAC 100, MAC 200, MAC 300, and MAC 400 in the user VLAN-ID A in the inner table 10020 of FIG. 9B. Similarly, a destination MAC corresponds to MAC 100, MAC 500, and MAC 600 in the user VLAN-ID B.

Next, the controller 50 makes inquiries about detailed information of the individual Box 31 and Box 40 based on the learnt MAC address of the Box 31 and the Box 40. Concretely, the controller 50 makes inquiries about the SN information of the Box 31 and the Box 40, and reconfirms the MAC address of the Box 30. The controller 50 transmits the unicast VSM frame with the user VLAN to the Box 31 and the Box 40 (9140).

The controller 50 receives the unicast VSR frame with the user VLAN from the Box 31 and the Box 40, and updates information of the previously prepared inner table based on the received contents of the unicast VSR frame (9160).

An inner table 10030 of FIG. 9C results from reflecting the received contents of the unicast VSR frame from the Box 30 on the inner table 10020. Here, since the above-described network 1 of FIG. 2 is taken as an example, in the inner table 10030 of FIG. 9C, the destination MACs of MAC 100, MAC 200, MAC 300, and MAC 400 correspond to the destination SNs of S000, S001, S002, and S003, respectively, in the user VLAN-ID A. Similarly, the destination MACs of MAC 100, MAC 500, and MAC 500 correspond to the destination SNs of S000, S004, and S004, respectively, in the user VLAN-ID B. When the inner table information 10030 of FIG. 9C is completed, the controller 50 reports the table contents to the operator side.

When the device registration and the Box-M/S registration work 3200 are performed by the operator, the controller 50 updates an inner table (9210). An inner table 10040 of FIG. 9B results from reflecting contents of the Box-M/S registration work 3200 from the operator on the inner table 10030. Here, since the above-described network 1 of FIG. 2 is taken as an example, in the inner table 10040 of FIG. 9D, the destination SNs of S000, S001, S002, and S003 correspond to the Box-M40, the Box-S1 (31A), the Box-S2 (31B), and the Box-S1 (31 C), respectively, in the user VLAN-ID A.

Similarly, the destination SNs of S000, S004, and S005 correspond to the Box-M40, the Box-S1 (31D), and the Box-S1 (31E), respectively, in the user VLAN-ID B.

Based on the table information of the inner table 10040, the controller 50 transmits the unicast VSM frame to the Box 31 and the Box 40 (9220). The controller 50 receives a Box M/S setting response from the Box through the unicast VSR frame (9230).

An inner table 10050 of FIG. 9E is prepared based on the information collected up to now. The inner table 10050 is prepared in combination with information on the inner table 10040 of FIG. 9D and that on the tables 4020 and 4040 of FIGS. 4B and 4D. The SN and the MAC address being information on the control device (controller 50) itself, the SN and the MAC address being information on the center side terminal device (Box-M40) accommodated in the controller 50, and the SN and the MAC address being information on the base side terminal device (Box-S31) accommodated in the Box-M40 are indicated in units of the user VLAN-ID. The above-described accommodation relationship is completed when the controller registration work 3100 and the Box-M/S registration work contents c3200 by the operator are performed.

Next, when the setting of the line parameter and the setting of the connectivity monitoring 3300 are performed by the operator, the controller 50 updates the inner table (9240). An inner table 10060 of FIG. 9F results from reflecting the setting of the line parameter and the setting contents of the connectivity monitoring by the operator on the inner table 10050.

Based on the table information of the inner table 10050, the controller 50 transmits the unicast VSM frame to the Box M/S (9250). The transmission contents of the VSM frame include the setting of the line parameter and the setting of the connectivity monitoring. The controller 50 receives a setting response from the Box-M/S through the unicast VSR frame (9260). The above indicates operation setting of the Box-M40 and the Box-S31 from the controller 50.

A dotted line portion of FIG. 8 indicates a sequence of the connectivity monitoring after operations of the Box-M40 and the Box-S31. The controller 50 starts the connectivity monitoring between itself and any of the Box-M40 and the Box-S31 (9339).

Concretely, based on the inner table 10060 of FIG. 9F, the controller 50 transmits the unicast CCM frame in units of the line parameter, that is, to the terminal ID (Box-S side) and the terminal ID (Box-M side). In the above-described example, since the MAC addresses of the Box-M40 and the Box-S31 accommodated in the controller 50 are grasped, the unicast CCM frame is used; further, the multicast CCM frame may be used. In this example, the unicast CCM frame is used in order to reduce a burden onto user traffic.

The controller 50 receives a response of the unicast CCM frame from the Box-M40 and the Box-S31 and finishes the connectivity monitoring between itself and any of the Box-M40 and the Box-S31 (9320). Further, the controller 50 summarizes results of the connectivity monitoring and updates the inner table (9330).

A sequence of the dotted line portion 9300 is repeatedly performed on a steady basis. When a CCM frame is not received for a given length of time, or an abnormality occurs in connectivity between the controller 50 and a relevant device, a report to the operator is promptly performed. Other than the above, a regular report to the operator is set to about five minutes. The above-described example is adamantly one example, and the present embodiment is not necessarily limited to the above-described example.

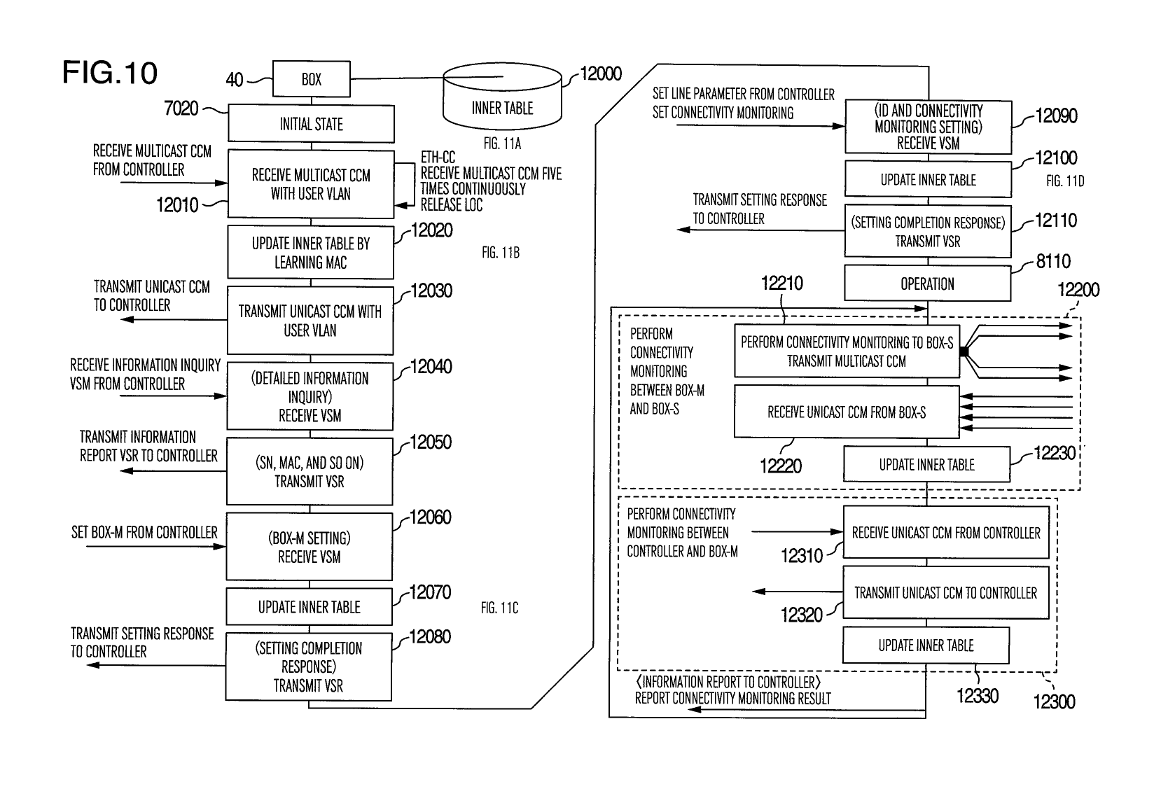

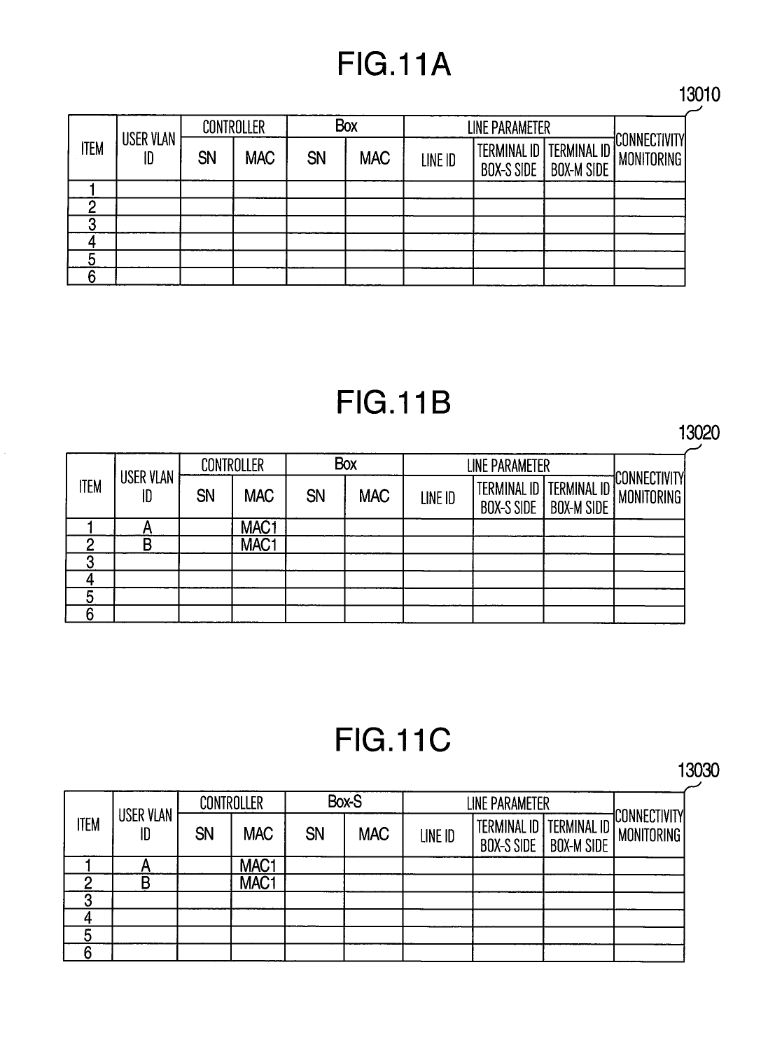

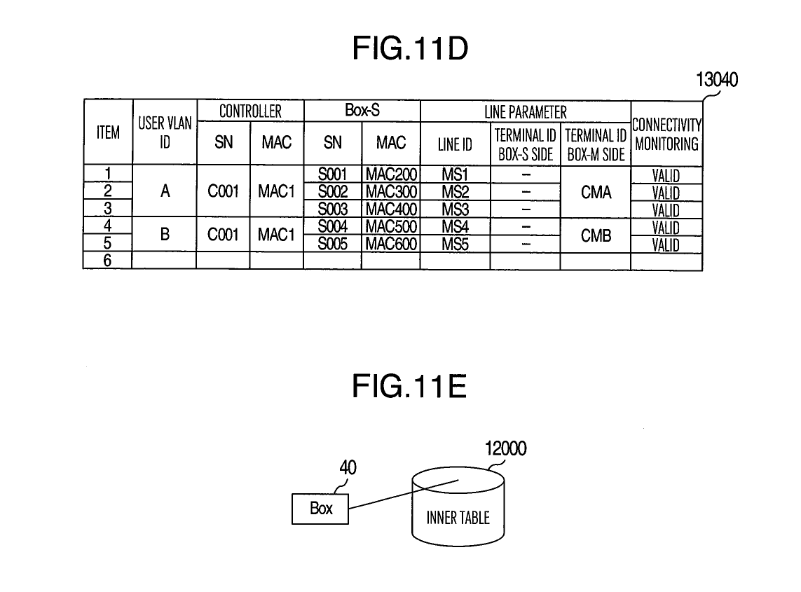

FIG. 10 illustrates one example of a process flow of the center side terminal device (Box-M40). The Box-M40 has an inner table 12000 (FIG. 11E). In the initial state 7020, an inner table 13010 of FIG. 11A is blank. When the multicast CCM frame with the user VLAN is continuously received from the controller 50 five times (12010), the Box-M40 releases an LOC (Loss Of Continuity). In the present embodiment, in order that the multicast CCM frame from other devices should not be erroneously learnt, the LOC is supposed to be not released until the multicast CCM frame is continuously received five times. Five-time continuous reception of the above-described example is adamantly one example, and the present embodiment is not necessarily limited to the above-described example.

Next, the Box-M40 learns the MAC address of the controller 50 being a transmission source MAC address of the multicast CCM frame received from the controller 50, and reflects the learnt MAC address on the inner table for updating (12020).

An inner table 13020 of FIG. 11B results from reflecting MAC learning results of the controller 50. Here, since the above-described network 1 of FIG. 2 is taken as an example, the MAC learning results include a MAC 1 of the user VLAN ID A and a MAC 1 of the user VLAN ID B from the controller 50.

The Box-M40 sets the learnt MAC address as a DA (destination address) and transmits the unicast CCM frame with the user VLAN to the controller 50 (12030). Further, the Box-M40 receives from the controller 50 the unicast VSM frame with the user VLAN for inquiring about detailed information (12040). With respect to the inquiry about the detailed information, the Box-M40 reports information on the SN and the MAC address of itself to the controller 50 through the unicast VSR frame with the user VLAN (12050).

Next, the Box-M40 receives from the controller 50 information for setting itself, namely, information for setting itself as a master Box through the unicast VSM frame with the user VLAN (12060). The Box-M40 receiving the information updates the inner table of itself (12070).

An inner table 13030 of FIG. 11C results from reflecting contents on the setting of the Box-M40 (setting as a master) by the controller 50. Since the controller 50 reports that the Box-M40 should start up as a master, the Box-M40 rewrites a portion to be described as the “Box” in the table 13020 into the “Box-S” in the table 13030. The reason is that the Box-M40 inside has information on the Box-M40 itself, namely, the SN and the MAC address, and that the Box-M40 needs to manage the information, namely, the SNs, and the MAC addresses of a plurality of Boxes-S31 in the case of operating as the Box-M40. The method is taken in order to delete the number of tables to be managed by the Box, namely, delete a memory amount.

Further, the Box-M40 transmits to the controller 50 the VSR frame for reporting that the setting is completed (12080).

The Box-M40 receives from the controller 50 information on the setting of the line parameter and the setting of the connectivity monitoring through the unicast VSM frame with the user VLAN (12090). When the unicast VSM frame with the user VLAN is received from the controller 50, the Box-M40 updates the inner table (12100).

An inner table 13040 of FIG. 11D results from reflecting setting of the SN information, setting of the line parameter, and setting of the connectivity monitoring valid information of the controller set by the controller 50 on the inner table 13030. Here, since the above-described network 1 of FIG. 2 is taken as an example, the SN information C001 of the controller 50 and information on the Box-S connected under the Box-M, namely, the SN and the MAC address (S001, S002, and S003 correspond to MAC200, MAC300, and MAC400, respectively), information on the line ID and the terminal ID (Box-M side) of the line parameter, and the valid setting information on the connectivity monitoring in the user VLAN ID A are updated. Here, “-” is written in fields of the terminal ID (Box-S side). The reason is that the Box-M does not manage the terminal ID (Box-S side) between the controller 50 and the Box-S. Similarly, the SN information C001 of the controller 50 and information on the Box-S connected under the Box-M, namely, the SN and the MAC address (S004 and S005 correspond to MAC500 and MAC600, respectively), information on the line ID and the terminal ID (Box-M side) of the line parameter, and the valid setting information on the connectivity monitoring in the user VLAN ID B are updated.

When the setting is normally completed, the Box-M40 transmits a setting response report to the controller 50 through the unicast VSR frame (12110). Further, the Box-M40 is in an operating state (8110).

Based on the information on the inner table 13040, the Box-M40 performs the connectivity monitoring between the Box-M40 and the Box-S31 (12200). In addition, the Box-M40 performs the connectivity monitoring between the controller 50 and the Box-M40 at the same time (12300).

About the connectivity monitoring between the Box-M40 and the Box-S31, the Box-M40 transmits the multicast CCM to a plurality of Boxes-S31 accommodated in units of the user VALN ID (12210). Further, the Box-M40 receives the unicast CCM from the Box-S31 (12220), updates the inner table based on the unicast CCM (12230), and reflects connectivity monitoring results on the inner table.

About the connectivity monitoring between the Box-M40 and the controller 50, the Box-M40 receives the unicast CCM from the controller 50 (12310). Further, the Box-M40 transmits the unicast CCM to the controller 50 (12320). The Box-M40 updates the inner table (12330), and reflects the connectivity monitoring results on the inner table.

A sequence (12200) for performing the connectivity monitoring between the Box-M40 and the Box-S31 and a sequence (12300) for performing the connectivity monitoring between the Box-M40 and the controller 50 are repeatedly performed on a steady basis. When a CCM frame is not received for a given length of time, or an abnormality occurs in connectivity between the controller 50 and a relevant device, a report to the operator is promptly performed. Other than the above, a regular report to the operator is set to about five minutes. The above-described example is adamantly one example, and the present embodiment is not necessarily limited to the above-described example.

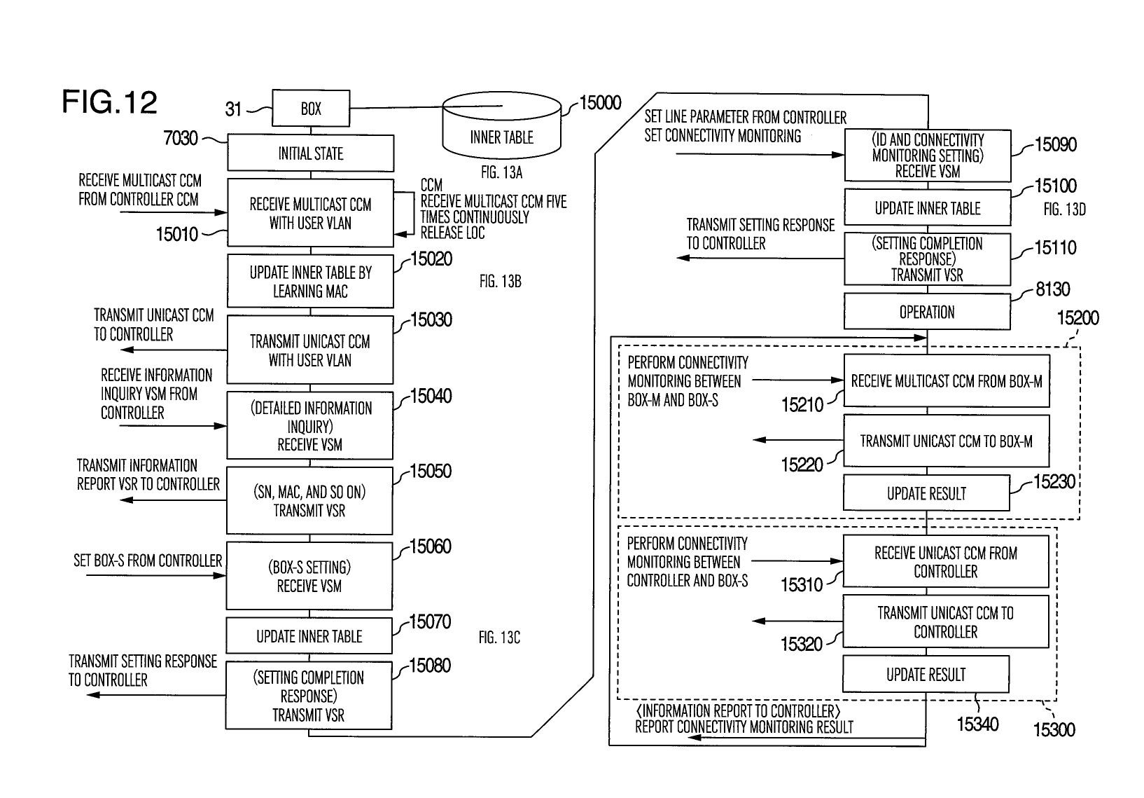

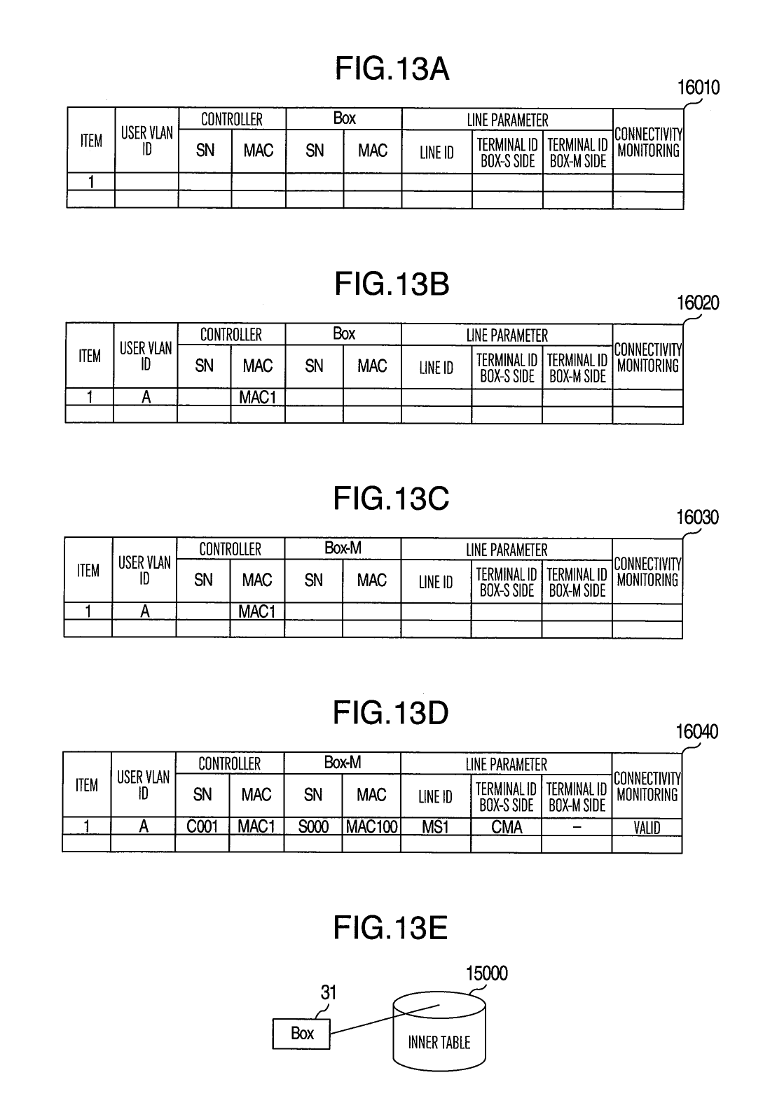

FIG. 12 illustrates one example of a process flow of the base side terminal device (Box-S). The Box-S31 has an inner table 15000 (FIG. 13E). In the initial state 7030, an inner table 16010 of FIG. 13A is blank. When the multicast CCM frame with the user VLAN is continuously received from the controller 50 five times (15010), the Box-S31 releases a LOC (Loss Of Continuity).

Next, the Box-S31 learns the MAC address of the controller 50 being a transmission source MAC address of the multicast CCM frame received from the controller 50, and reflects the learnt MAC address on the inner table for updating (15020).

An inner table 16020 of FIG. 13B results from reflecting the MAC learning result of the controller 50 on the inner table. Here, since the above-described network 1 of FIG. 2 is taken as an example, the MAC learning result includes a MAC 1 of the user VLAN ID A from the controller 50. Since other Boxes-S belong to a network of the user VLAN ID B, only the Box-S1 (31A) belonging to a network of the user VLAN ID A is described.

The Box-S31 sets the learnt MAC address as a DA (destination address) and transmits the unicast CCM frame with the user VLAN to the controller 50 (15030). Next, the Box-S31 receives from the controller 50 the unicast VSM frame with the user VLAN for inquiring about detailed information (15040). The Box-S31 receiving the unicast VSM frame reports information on the SN and the MAC address of itself to the controller 50 through the unicast VSR frame with the user VLAN (15050).

Next, the Box-S31 receives from the controller 50 information for setting the Box-S1 (31A), namely, information for setting the Box-S31 as a slave Box through the unicast VSM frame with the user VLAN (15060). The Box-30 updates the inner table of itself (15070).

An inner table 16030 of FIG. 13C results from reflecting contents on the setting of the Box-S1 (31A) by the controller 50. Since the controller 50 reports that the Box-30 should start up as the Box-S1 (31A), the Box-30 rewrites a portion to be described as the “Box” in the table 16020 into the “Box-M” in the table 16030. The reason is that the Box-S1 (31A) itself inside has information on the Box-S1 (31A) itself, namely, the SN and the MAC address, and that the Box-S31 needs to manage the information on the Box-M40 to be terminated, namely, the SN and the MAC address in the case of operating as the Box-S1 (31A).

Further, the Box-S31 transmits to the controller 50 the VSR frame for reporting that the setting is completed (15080).

Next, the Box-S31 receives from the controller 50 information on the setting of the line parameter and the setting of the connectivity monitoring through the unicast VSM frame with the user VLAN (15090). When the unicast VSM frame with the user VLAN is received from the controller 50, the Box-S31 updates the inner table (15100).

An inner table 16040 of FIG. 13D results from reflecting the SN information of the controller set by the controller 50, the setting of the line parameter, and the setting of the connectivity monitoring valid information on the inner table 16030. Here, since the above-described network 1 of FIG. 2 is taken as an example, the SN information C001 on the controller 50 and information on the Box-M, namely, the SN and the MAC address (S000 corresponds to MAC100), information on the line ID and the terminal ID (Box-S side) in the line parameter, and the valid setting information on the connectivity monitoring in the user VLAN ID A are updated. Here, “-” is written in fields of the terminal ID (Box-M side). The reason is that the Box-M does not manage the terminal ID (Box-M side) between the controller 50 and the Box-M.

When the setting is normally completed, the Box-S1 (31A) transmits a setting response report to the controller 50 through the unicast VSR frame (15110). Further, the Box-S31 is in an operating state (8130).

Based on the information on the inner table 16040, the Box-S31 performs the connectivity monitoring between the Box-M40 and the Box-S31 (15200). In addition, the Box-S31 separately performs the connectivity monitoring between the controller 50 and the Box-S31 (15300).

About the connectivity monitoring between the Box-S31 and the Box-M40, the Box-S31 receives the unicast CCM from the Box-M40 (15210). Further, the Box-S31 transmits the unicast CCM to the Box-M40 (15320). Further, the Box-S31 updates the inner table in accordance with an exchange of the unicast CCM frame between the Box-S31 and the Box-M40 (15230), and reflects connectivity monitoring results on the inner table.

About the connectivity monitoring between the Box-S31 and the controller 50, the Box-S31 receives the unicast CCM from the controller 50 (15310). Further, the Box-S31 transmits the unicast CCM to the controller 50 (15320). The Box-S31 updates the inner table in accordance with an exchange of the unicast CCM frame between the Box-S31 and the controller 50 (15340), and reflects connectivity monitoring results on the inner table.

A sequence (15200) for performing the connectivity monitoring between the Box-M40 and the Box-S31 and a sequence (15300) for performing the connectivity monitoring between the Box-S31 and the controller 50 are repeatedly performed on a steady basis. When a CCM frame is not received for a given length of time, or an abnormality occurs in connectivity between the Box-S31 and a relevant device, a report to the operator side is promptly performed by the Box-S31. Other than the above, a regular report to the operator side is set to about five minutes. The above-described example is adamantly one example, and the present embodiment is not necessarily limited to the above-described example.

As described above, in the present embodiment, a terminal device (hereinafter, referred to as a terminal device) that can terminate the Ethernet OAM frame specified by recommendation of IEEE 802. lag and ITU-T Y. 1731 is installed at a user's base. Further, normality monitoring between bases is achieved from end to end between terminal devices by using a CCM frame. Further, a control device (controller) that controls the terminal device is installed in a VLAN network used by a user. A method for establishing a control route of the terminal device from the controller is performed by MAC address learning and transmission and reception of a CCM frame between the controller and the terminal device. Concretely, a CCM frame with a multicast address is transmitted to each terminal device in a VLAN network used by the same user from the controller. When the CCM frame with the multicast address is received, each terminal device transmits a CCM frame with a unicast address to the controller. The controller learns a MAC address of an object terminal device based on the CCM frame with the unicast address from each terminal device.

After the MAC address learning, an object device can be identified by a MAC address and a channel for control can be established. The terminal device is controlled by the controller through an independently-specified control frame. To a format of the control frame, in-channel communication of a layer 2 can be applied by using a VSM/VSR (Vender-Specific OAM Message/Vender-Specific OAM Reply) of an Ethernet OAM. The above-described format of the control frame is adamantly one example, and not limited to usage of the VSM/VSR.

The controller that establishes a control route with the terminal device performs table management in units of a VLAN network in which the user uses information on the terminal device based on the MAC learning result and the report information on a control frame. Table information on the controller can be reported to an operator side and collectively managed. The operator sets a subordinate relationship to terminal devices and determines an upper-side (master) terminal device and a plurality of lower-side (slave) terminal devices. The controller reports the set contents to each terminal device through the control frame based on the set table information. Based on the set contents, each terminal device operates. About the connectivity monitoring, both of monitoring of a main signal route and that of a control route are performed. Concretely, the connectivity monitoring of the main signal route is performed through the CCM frame between the master terminal device and the slave terminal device. Further, the connectivity monitoring of the control route is performed through the CCM frame also between the controller and each terminal device. In a connectivity monitoring segment, an ID managed by the operator is specified, and monitored and managed in units of segments.

As described above, each terminal device can be remotely controlled through the controller 50 under the leadership of an operator from a MAC address learnt by the controller 50. The operator can manage and prepare collectively tables indicating connection information between respective terminal devices that make a connection between bases in an L2-VPN service area and connection information between a controller and each terminal device. Based on the above, the operator can confirm normality of not only a main signal route through which a user frame flows but also a control route. When a connectivity monitoring segment becomes apparent, a terminal failure in case of trouble or a failure portion at the time of a communication path error is easily identified. Further, when an unnecessary failure report is reduced, a burden onto user traffic can be relieved.

It should be further understood by those skilled in the art that although the foregoing description has been made on embodiments of the invention, the invention is not limited thereto and various changes and modification may be made without departing from the spirit of the invention and the scope of the appended claims.

### REFERENCE SIGNS LIST

1 Network
10 L2 VPN network
31 Box-S
40 Box-M
50 Controller
6100 Line ID
6200 Terminal ID (Box-M side)
6300 Terminal ID (Box-S side)

1. A control device to manage in each virtual local area network (VLAN) a plurality of terminal devices that transmit and receive a frame for confirming connectivity between devices belonging to the same VLAN, comprising:
means for transmitting in each of the VLANs a multicast frame to the terminal device belonging to the VLAN;
means for obtaining as a media access control (MAC) address of the terminal device a transmission source address of the frame transmitted to the control device from each of the terminal devices after transmission of the multicast frame; and
means for inquiring of, by using the obtained MAC address through a first unicast frame, each of the terminal devices about identification information of the terminal device for uniquely discriminating the terminal device and obtaining the identification information.

2. The control device according to claim 1, further comprising means for reporting to each of the terminal devices, by using the obtained MAC address through a second unicast frame, that the terminal device is a device that plays a role as a master collectively confirming connectivity between the terminal device and the another terminal device belonging to the same VLAN as that of the terminal device, or that serves as a slave belonging to the another terminal device that plays a role as the master.

3. The control device according to claim 2, further comprising means for reporting to each of the terminal devices, by using the obtained MAC address through a third unicast frame, identification information of a line for identifying a line segment and confirming connectivity between the terminal device and the another terminal device belonging to the same VLAN as that of the terminal device.

4. The control device according to claim 1, wherein the multicast frame is a continuity check message (CCM) frame being an operation administration and maintenance (OAM) signal of an Ethernet.

5. The control device according to claim 3, wherein the first to third unicast frames are vender-specific OAM message (VSM) frames being an OAM signal of an Ethernet.

6. The control device according to claim 1, wherein identification information of the terminal device is a serial number peculiar to the terminal device.
